(19) United States
(12) Patent Application Publication
(10) Pub. No.: US 2026/0280606 A1
(43) Pub. Date: Sep. 17, 2026

(54) SELECTION OF TRANSMITTERS IN AN INDOOR RADIO SYSTEM

(71) Applicant: Telefonaktiebolaget LM Ericsson (publ), Stockholm (SE)

(72) Inventors: Géza SZABÓ, Kecskemét (HU); Csaba GYÖRGYI, Nyiregyhaza (HU); Péter VÖRÖS, Budapest (HU); Sandor LAKI, Budapest (HU)

(21) Appl. No.: 18/878,157

(22) PCT Filed: Aug. 2, 2023
(86) PCT No.: PCT/EP2023/071437

§ 371 Date: Dec. 23, 2024

Related U.S. Application Data
(60) Provisional application No. 63/397,920, filed on Aug. 15, 2022.

(51) Int. Cl. H04B 7/024; H04L 41/0893; H04W 40/12; H04W 40/24

(52) U.S. Cl. CPC H04B 7/024; H04L 41/0893; H04W 40/12; H04W 40/248

(57) ABSTRACT

A method of selection of transmitters in an indoor radio system is provided. The method includes receiving an output from a digital twin of the indoor radio system. The output includes indicators of a radio propagation property of a signal between a receiver and a respective transmitter. The method further includes filtering at least some of the transmitters into subsets of transmitters that are active for the receiver based on the outputted indicators. The method further includes generating a first message including an identifier per transmitter in the subsets of transmitters for the receiver. The method further includes transmitting the first message towards a device for selection of a transmitter per subset of transmitters for the receiver. A method performed by a device, and related apparatus and methods are also provided.

### TECHNICAL FIELD

The present disclosure relates generally to methods for selecting transmitters in an indoor radio system, and related methods and apparatuses.

### BACKGROUND

Digital twins (DT) may be used in the communications industry for a variety of applications including, for example, fifth generation (5G) network related DTs. The Internet of Things (IoT) is gaining ground and may be increasingly popular in smart city applications such as smart energy, smart buildings, smart factories, smart transportation, smart farming, smart healthcare, etc.; and a DT concept may be evolving as complementary to a counterpart to an IoT physical part. Among other things, a DT may be able to assess performance, predict the impact of an environment change, and/or optimize the 5G network processes of a network (e.g., a 5G network) and decision making accordingly.

Presently, programmable routers may provide more functionality than pure packet forwarding. A programmable router may open up an ability for low latency calculations on an application level during the communication. More specifically, a programmable router may split long, distant control loops into smaller ones to deal with transport latency. Industrial communication may be a field where control loop latency may be emerging with high importance.

Coordinated multipoint (COMP) transmission and reception, which may allow a user equipment (UE) to be served by multiple cooperating base stations (BSs), may be an approach to enhance spectral efficiency and link reliability but at the price of increased overhead. A CoMP operation can be implemented with a set of indoor small cells, sometimes referred to as a radio dot (indoor radio antennas) system (RDS). A present mode of operation of a RDS includes all dots assigned to one cell where all dots are always actively transmitting and receiving. To achieve this in downlink, an indoor radio unit (IRU) may duplicate a transmission (Tx) signal from a baseband unit to the dots.

A motivation of the application of CoMP includes to eliminate the effect of handover between cells for UEs. CoMP may be used for broadband UEs, e.g., for switching between an indoor and an outdoor environment when entering/exiting a building when macro cells and the indoor micro cells operate in a CoMP mode.

There currently exist certain challenges. In an industrial environment, e.g., shortcomings of indoor radio systems (e.g., in a CoMP mode) may be accepted in exchange for a possible handover less experience, e.g., for mobile actuators such as automated guided vehicles (AGVs) in production cells. Shortcomings may include, e.g., that only a portion of the dots or transmitters within a cell may primarily contribute to a desired signal at the receiver; however, all of the dots or transmitters may anonymously spill interference to adjacent cells (e.g., such as in open areas with few walls, such as an industrial environment).

### SUMMARY

Certain aspects of the disclosure and their embodiments may provide solutions to these or other challenges. Various embodiments include a DT, or output from a DT, that may obtain predictions into the future of indicators of a radio propagation property of a signal between a receiver and a transmitter(s) in an indoor radio system. Inclusion of the output of the DT may be used to identify and select a transmitter (e.g., rather than all transmitters) from of transmitters for the receiver. The DT may perform load balancing based on the actual networking traffic and a current active set of transmitters.

Certain embodiments may provide one or more of the following technical advantages. Since packets are not sent through transmitters that are mot selected, potential technical advantages may include reduction of network traffic (e.g., significant reduction), which may improve the quality of the network.

Various embodiments of the present disclosure provide a method of selection of transmitters in an indoor radio system. The method includes receiving an output from a digital twin of the indoor radio system. The output may include a plurality of indicators of a radio propagation property of a signal between a receiver and a respective transmitter from a plurality of transmitters in the indoor radio system. The method further includes filtering at least some of the plurality of transmitters into a plurality of subsets of transmitters that are active for the receiver based on the outputted plurality of indicators; and generating a first message including an identifier per transmitter in the plurality of subsets of transmitters for the receiver. The method further includes transmitting the first message towards a device for selection of a transmitter per subset of transmitters for the receiver.

In other embodiments, a method performed by a device for selection of transmitters in an indoor radio system is provided. The method includes receiving a first message including an identifier per transmitter in a plurality of subsets of transmitters for a receiver. The method further includes selecting for the receiver, based on information from the first message, a transmitter per subset of transmitters that has a lowest load value among the subset of transmitters.

In other embodiments, a network node is provided. The network node includes processing circuitry; and memory coupled with the processing circuitry that when executed by the processing circuitry causes the network node to perform operations. The operations include to receive an output from a digital twin of the indoor radio system. The output may include a plurality of indicators of a radio propagation property of a signal between a receiver and a respective transmitter from a plurality of transmitters in the indoor radio system. The operations further include to filter at least some of the plurality of transmitters into a plurality of subsets of transmitters that are active for the receiver based on the outputted plurality of indicators; and to generate a first message including an identifier per transmitter in the plurality of subsets of transmitters for the receiver. The operations further include to transmit the first message towards a device for selection of a transmitter per subset of transmitters for the receiver.

In other embodiments, a network node adapted to perform operations is provided. The operations include to receive an output from a digital twin of the indoor radio system. The output may include a plurality of indicators of a radio propagation property of a signal between a receiver and a respective transmitter from a plurality of transmitters in the indoor radio system. The operations further include to filter at least some of the plurality of transmitters into a plurality of subsets of transmitters that are active for the receiver based on the outputted plurality of indicators; and to generate a first message including an identifier per transmitter in the plurality of subsets of transmitters for the receiver. The operations further include to transmit the first message towards a device for selection of a transmitter per subset of transmitters for the receiver.

In other embodiments, a computer program comprising program code to be executed by processing circuitry of a network node is provided, whereby execution of the program code causes the network node to perform operations. The operations include to receive an output from a digital twin of the indoor radio system. The output may include a plurality of indicators of a radio propagation property of a signal between a receiver and a respective transmitter from a plurality of transmitters in the indoor radio system. The operations further include to filter at least some of the plurality of transmitters into a plurality of subsets of transmitters that are active for the receiver based on the outputted plurality of indicators; and to generate a first message including an identifier per transmitter in the plurality of subsets of transmitters for the receiver. The operations further include to transmit the first message towards a device for selection of a transmitter per subset of transmitters for the receiver.

In other embodiments, a computer program product comprising a non-transitory storage medium including program code to be executed by processing circuitry of a network node is provided, whereby execution of the program code causes the network node to perform operations. The operations include to receive an output from a digital twin of the indoor radio system. The output may include a plurality of indicators of a radio propagation property of a signal between a receiver and a respective transmitter from a plurality of transmitters in the indoor radio system. The operations further include to filter at least some of the plurality of transmitters into a plurality of subsets of transmitters that are active for the receiver based on the outputted plurality of indicators; and to generate a first message including an identifier per transmitter in the plurality of subsets of transmitters for the receiver. The operations further include to transmit the first message towards a device for selection of a transmitter per subset of transmitters for the receiver.

In other embodiments, a device is provided. The device includes processing circuitry; and memory coupled with the processing circuitry that when executed by the processing circuitry causes the device to perform operations. The operations include to receive a first message including an identifier per transmitter in a plurality of subsets of transmitters for a receiver. The operations further include to select for the receiver, based on information from the first message, a transmitter per subset of transmitters that has a lowest load value among the subset of transmitters.

In other embodiments, a device adapted to perform operations is provided. The operations include to receive a first message including an identifier per transmitter in a plurality of subsets of transmitters for a receiver. The operations further include to select for the receiver, based on information from the first message, a transmitter per subset of transmitters that has a lowest load value among the subset of transmitters.

In other embodiments, a computer program comprising program code to be executed by processing circuitry of a device is provided, whereby execution of the program code causes the device to perform operations. The operations include to receive a first message including an identifier per transmitter in a plurality of subsets of transmitters for a receiver. The operations further include to select for the receiver, based on information from the first message, a transmitter per subset of transmitters that has a lowest load value among the subset of transmitters.

In other embodiments, a computer program product comprising a non-transitory storage medium including program code to be executed by processing circuitry of a device is provided, whereby execution of the program code causes the device to perform operations. The operations include to receive a first message including an identifier per transmitter in a plurality of subsets of transmitters for a receiver. The operations further include to select for the receiver, based on information from the first message, a transmitter per subset of transmitters that has a lowest load value among the subset of transmitters.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1A is a schematic diagram illustrating an overview of an example embodiment including an indoor radio according to some embodiments of the present disclosure;

FIG. 1B is a block diagram illustrating an example system of components and operations in accordance with some embodiments of the present disclosure;

FIG. 2 is a flow chart of operations of a filter in accordance with some embodiments of the present disclosure;

FIG. 3 is a block diagram illustrating an example artificial intelligence (AI)-aided system of components and operations in accordance with some embodiments of the present disclosure;

FIG. 4 is a flow chart of operations of an AI-aided filter in accordance with other embodiments of the present disclosure;

FIG. 5 is a flowchart of operations for processing control packets in accordance with an example embodiment of the present disclosure;

FIG. 6 is a flowchart of operations, including some components, of an example embodiment of the data plane pipeline of group-wise load in accordance with an example embodiment of the present disclosure;

FIG. 7 is a flow chart illustrating operations of a network node according to some embodiments of the present disclosure;

FIGS. 8A and 8B are flow charts illustrating operations of a device according to some embodiments of the present disclosure;

FIG. 9 is a block diagram illustrating a device according to some embodiments of the present disclosure; and

FIG. 10 is a block diagram illustrating a network node according to some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter. The term “device” is used in a non-limiting manner and can refer to any type of component in an indoor radio unit (or an equipment performing the functions of an indoor radio unit as discussed further herein. The term “network node” in the context of selection of transmitters in an indoor radio system is used in a non-limiting manner and can refer to any type of node communicatively coupled or including a DT and/or a filter (as discussed further herein). The network node (including the DT and/or filter) is communicatively coupled to the indoor radio system (e.g., a network node in a cloud, a virtual network function in a cloud, a network node in the indoor radio system, etc.). In this context, the term “network node” herein may be interchangeable and replaced with the terms “computing device” and/or “cloud-based computing device”.

As previously discussed, shortcomings of indoor radio systems (e.g., in a CoMP mode) may include that communication of relatively distant receivers (e.g., robots in an indoor industrial environment) may cause interference and/or cause communication bottlenecks; and unnecessary/unused transmitters may still consume energy. Additionally, while measurements provided by a radio access network (RAN) may be sufficient to provide a reactive method, time is needed for the measurement to be performed, cleared, filtered for further processing, processed, and/or to act according to a certain logic.

Various embodiments of the present disclosure may provide solutions to these and other challenges. Inclusion of a DT may make it possible to look into the future based on a level of detail of the DT, for example, in an industrial environment in which processes are planned in detail in advance. In such an indoor radio system, a DT may make it possible to make predictions into the future (e.g., a prediction that is seconds, minutes, or hours long). Further, the DT may act as a simulation environment and may create scenarios that may rarely occur and may not include many (or any) measurement opportunities.

The DT may be a cloud DT for a 5G network that seeks to perform continuous assessment, monitoring, and proactive maintenance through closed-loop data from physical entities to virtual counterparts and vice versa. Within the 5G DT, a digital 5G model may run alongside the physical 5G network to perform operational predictions and enforce optimized/improved decisions into the living network and associated services. The DT may provide a list of transmitters (e.g., an active set of transmitters) per receiver (e.g., robots) indicating which transmitter can actually reach the receiver.

As discussed further herein, various embodiments include a method for selection of transmitters in an indoor radio system. The method includes receiving an output from a DT of the indoor radio system. The output includes a plurality of indicators of a radio propagation property of a signal between a receiver and a respective transmitter from a plurality of transmitters in the indoor radio system. The method further includes filtering at least some of the plurality of transmitters into a plurality of subsets of transmitters that are active for the receiver based on the outputted plurality of indicators. The method further includes generating a first message including an identifier per transmitter in the plurality of subsets of transmitters for the receiver. The method further includes transmitting the first message towards a device for selection of a transmitter per subset of transmitters for the receiver.

As a consequence, a portion of the transmitters get and transmit packets arriving from the outside world (e.g., controllers) towards the receivers (e.g., robots). In some embodiments, unused transmitters can be turned off depending on the overhead of the on-off switching.

In some embodiments, an artificial intelligence (AI)-aided filtering component may increase complexity of supported applications of the method, as the AI-aided filtering component may learn and predict additional information (e.g., such as movement of actuators/robots in a given production cell).

The work of the DT may be enabled by an in-network component (e.g., a P4 programmable switch/device including a programmable switch). The DT may perform additional load balancing based on the actual networking traffic and a current active set of transmitters.

Since packets are not sent through transmitters that cannot reach the destination receiver, potential technical advantages may include reduction of network traffic (e.g., significant reduction), which may improve the quality of the network.

Based on the inclusion of an in-network component (e.g., a P4 programmable switch), further potential technical advantages may include an increase in performance (e.g., based on additional information gained from actual traffic) using load balancing. The load balancing may be based on predictions of the DT and the actual traffic passing through the in-network component. A further potential technical advantage may be that the in-network component may be implemented in a programmable switch (e.g., a P4 programmable switch) which may have a small computational and memory overhead and small implementation complexity (e.g., working with Barefoot Tofino).

As discussed further herein, some embodiments include dynamic on-off switching with a real-time radio propagation based DT. Output of the DT may be fed to a filtering component containing a deterministic white box or AI-based black box component(s). The output of the filtering may be fed to the in-network component of the network node to provide line-rate switching.

Some embodiments of the method of the present disclosure combine operations of a DT component and a programmable packet processing circuit (e.g., Intel Tofino ASIC). Various embodiments include a load balancing scheme realized based on the programmable packet processing circuit.

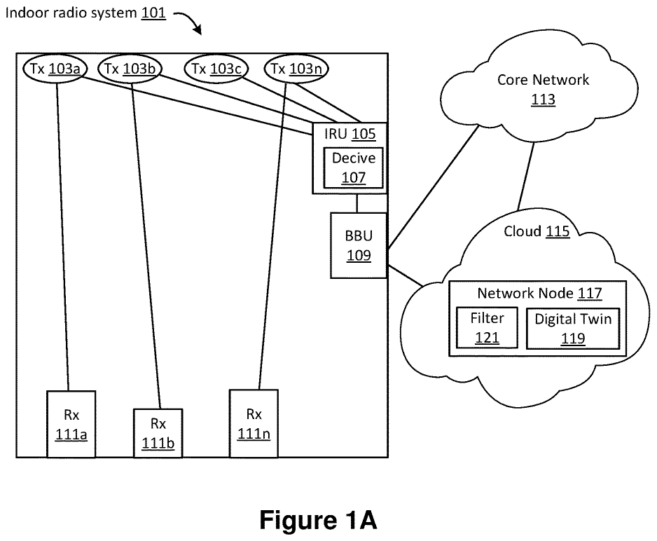

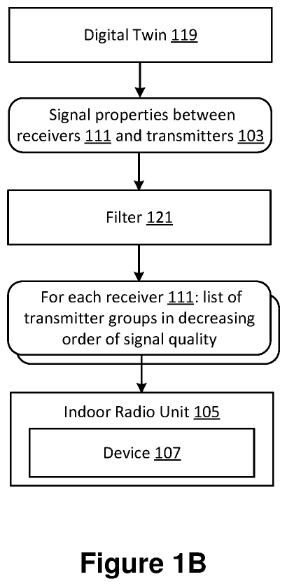

FIG. 1A is a schematic diagram illustrating an overview of an example embodiment including an indoor radio system 101 communicatively connected to a core network 113 and cloud 115. As illustrated, indoor radio system 101 includes a plurality of transmitters (Txs) 103a, 103b, 103c, 103n (one or more of which may be generally referred to as transmitters 103). Transmitters 103 may be, for example, radio dots. While the example embodiment of FIG. 1A depicts four transmitters 103, the invention is not so limited, and may include any non-zero number of transmitters. The illustrated indoor radio system 101 further includes plurality of receivers (Rxs) 111a, 111b, 111n (one or more of which may be generally referred to as receivers 111). Receivers 111 may be, for example, robots or actuators. While the example embodiment of FIG. 1A depicts three receivers 111, the invention is not so limited, and may include any non-zero number of receivers.

Indoor radio system 101 may be a telecommunication network that includes an access network, such as a RAN, and a core network 113, which includes one or more core network nodes. The access network may include one or more access network nodes or any other similar 3rd Generation Partnership Project (3GPP) access node or non-3GPP access point. The network node 1000 may facilitate direct or indirect connection of devices (such as device 900 discussed further herein), transmitters 103, and/or receivers 111

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the indoor radio system 101 may include any number of wired or wireless networks, network nodes, devices, UEs, and/or any other components or systems that may facilitate or participate in the communication of data and/or signals whether via wired or wireless connections. The indoor radio system 101 may include and/or interface with any type of communication, telecommunication, data, cellular, radio network, and/or other similar type of system.

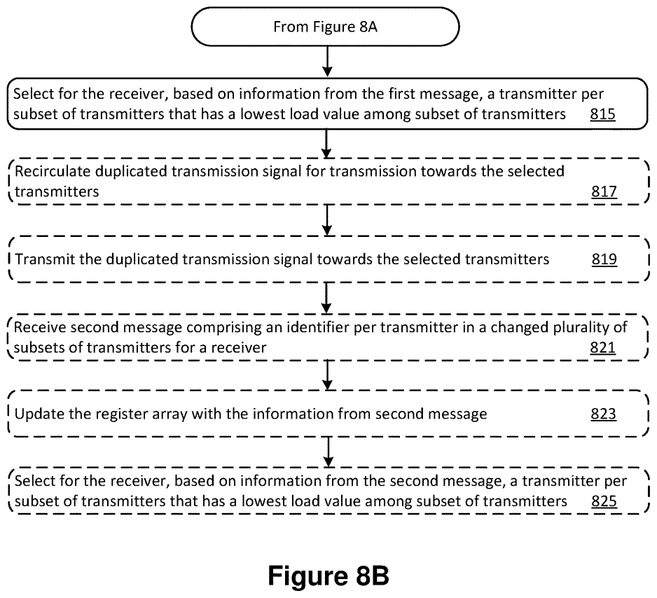

Still referring to FIG. 1A, the illustrated indoor radio system 101 further includes an indoor radio unit 105. Indoor radio unit (IRU) 105 may further include device 107 (which may be implemented using the structure of device 900 of FIG. 9). IRU 105 may be a component of a radio dot system or other indoor radio system having a plurality of transmitters and receivers. IRU 105 may be used together with the transmitters 103 to have full radio functionality. IRU 105 may include an interface to a digital unit, such as baseband unit (BBU) 109 (e.g., through a common public radio interface (CPRI) cable). IRU 105 may provide signaling and a power interface to transmitters 103 over a radio interface. IRU 105 also may collect external alarms and transmit them to the digital unit, such as BBU 109. BBU 109 may include baseband processing circuitry, which may be on separate chips (or sets of chips), boards, or units, such as radio units and digital units. In alternative embodiments, part or all of baseband processing circuitry may be on the same chip or set of chips, boards, or units.

In the illustrated example of FIG. 1A, core network connects to network node 117 and indoor radio system 101. These connections may be direct or indirect via one or more intermediary networks or devices. The core network 113 includes one more core network nodes that are structured with hardware and software components. Features of these components may be substantially similar to those described with respect network nodes (discussed further herein), such that the descriptions thereof are generally applicable to the corresponding components of core network nodes. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

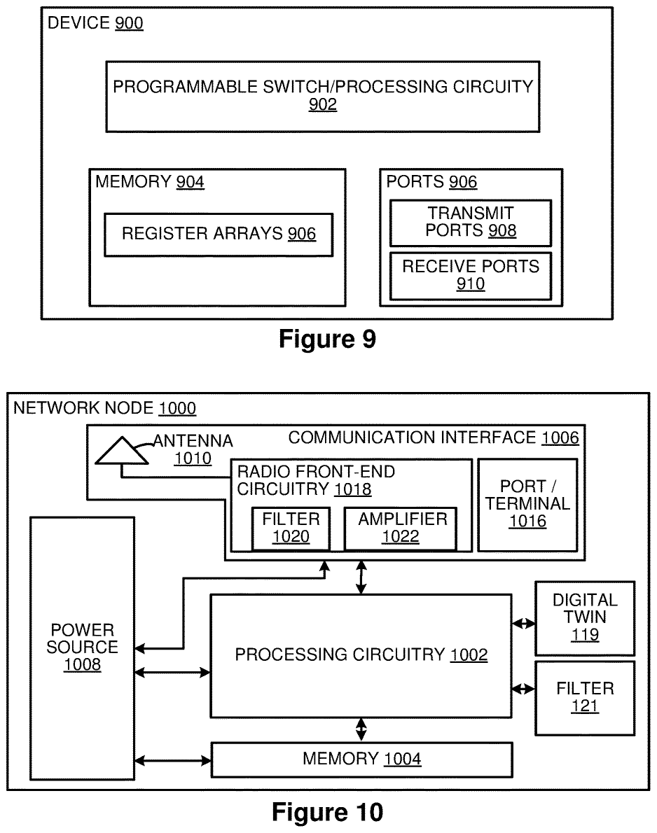

Cloud 115 includes network node 117. Cloud 115 may further include various combinations of hardware and/or software (e.g., a standalone server, a blade server, a cloud-implemented server, a distributed server, a virtual machine, container, or processing resources in a server farm). Network node 117 (which may be implemented using the structure of device 1000 of FIG. 10) may include digital twin (DT) 119 and filter 121 or may be communicatively coupled to DT 119 and filter 121.

FIG. 1B is a block diagram illustrating an example system of components and operations in accordance with some embodiments of the present disclosure. The system includes a radio propagation digital twin 119 simulating the environment and the radio propagation properties of signals between receivers 111 and transmitters 103 (e.g., radio dots) in or near real time. As illustrated in FIG. 1B, digital twin 119 outputs different properties of the signal for each receiver 111-transmitter 103 pair, which is handed to filter 121.

Filter 121 groups the transmitters 103 for each receiver 111 according to the signal properties given by the digital twin 119. In the example embodiment of FIG. 1B, for each receiver 111, a list of transmitters 111 is provided in decreasing order of signal quality (derived from the information given by digital twin 119) and pairs with similar quality value are formed. Accordingly, the first two transmitters 111 with the best quality belong to the first group, two transmitters with the third and fourth best quality values form the second group, etc. While this example embodiment is described for such a grouping, other groupings may be used, including without limitation, groupings in increasing order of signal quality. Further, while this example embodiment is explained in the non-limiting context of groups of transmitters where each group has the same number of transmitters (except that the last group may have less), the present disclosure is not so limited and includes any number (e.g., two or more) transmitters in a group (except for the last group which may have fewer transmitters). The groups may be encoded into a special message (e.g., a user datagram protocol (UDP)-based control packet) and sent to the programmable packet processing circuit in device 107 (e.g., programmable switch/processing circuitry 902 of device 900 of FIG. 9) in IRU 105. In some embodiments, this message is a special network packet or frame that is fully processed by the programmable packet processing circuit.

In some embodiments, filter 121 filters out some transmitters 103 in advance and does not add them to any groups (e.g., where a signal quality indicator is below a threshold or considering only the K transmitters 103 with the best quality). Filter 121 may be used to limit the active transmitter 103 set that the packet processing circuit needs to be handle, which may result in lower resource usage in the programmable packet processing circuit component.

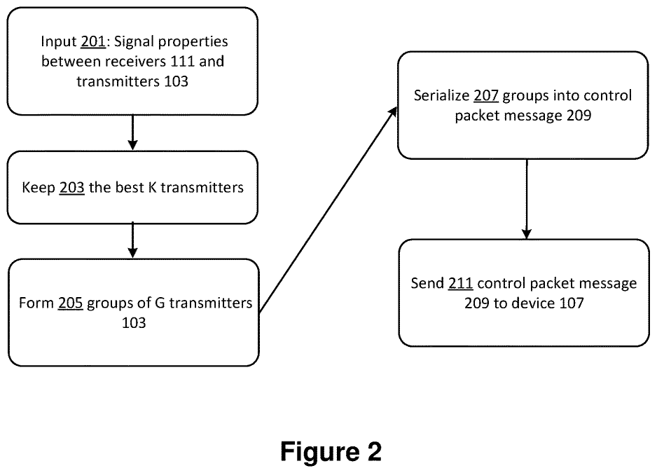

FIG. 2 is a flow chart of operations of a filter in accordance with some embodiments of the present disclosure. The filter (e.g., filter 121) receives input 201 including signal properties between a receiver 111 and all transmitters 103. A parameter K refers to only the best K transmitters, and a parameter G refers to the size of the transmitter groups used in the load balancing. In operation 203, the filter keeps the best K transmitters. For example, S′=(transmitter|sqi(receiver, transmitter)>=Tₖ), where Tₖ is the Kth best signal quality indicator (sqi) between the receiver 111 and the transmitters 103. In operation 205, the filter groups the best K transmitters into groups of G transmitters. For example, each group G may include transmitters 103 with similar signal quality indicators. It is noted, however, that the last group may have fewer transmitters 103. In operation 207, the filter serializes the groups G into a control packet message 209. For example, an identifier of each transmitter 103 may be listed sequentially in the control packet. The last group in the sequence may have fewer transmitters 103. In operation 211, the filter sends the control packet message 209 to device 107.

In some embodiments, the programmable packet processing circuit of device 107 in IRU 105 is responsible for forwarding the signal coming from BBU 109 to the transmitters 103. In COMP transmission without the method of the present disclosure, the signal is forwarded to all the transmitters. In the method of the present disclosure, the signal towards a given receiver 111 is only forwarded to a subset of transmitters 103. Load balancing of embodiments of the present disclosure relies on accurate and real-time/near real-time load information of the transmitters 111 and the transmitter 111 groups given by filter 121. The method may select the less loaded transmitters 103 from each group. As a consequence, the group-wise load balancing may be simple and lightweight. Implementation in programmable packet processing circuits, however, may be challenging. Alternatively, as discussed further herein, in some embodiments, a random selection-based scheme in the packet processing circuit may be used.

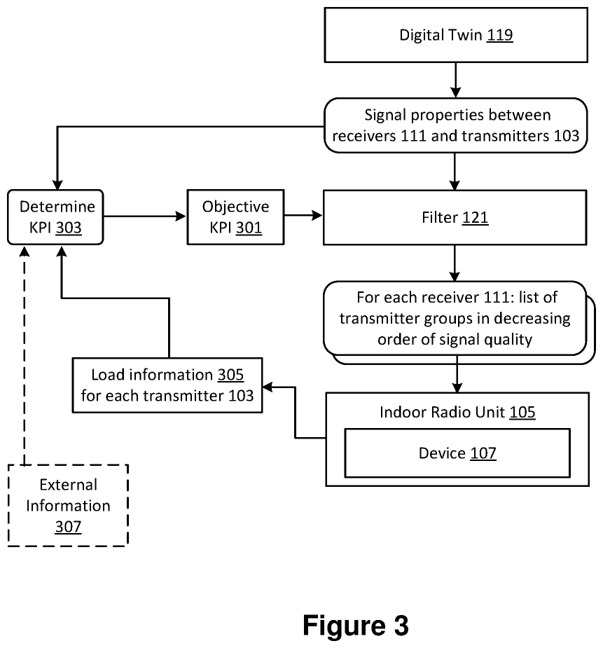

FIG. 3 is a block diagram illustrating an example AI-aided system of components and operations in accordance with some embodiments of the present disclosure. The AI-aided system of FIG. 3 extends the system of the FIG. 2 with an AI-aided filter for grouping the transmitters 103. For ease of discussion, differences are described compared to the system of FIG. 2. Thus, components and operations that may be substantially similar to those described with respect to FIG. 2 are not repeated, such that the descriptions thereof are generally applicable to the corresponding components/operations of FIG. 3.

In FIG. 3, the filter component is replaced with an AI-aided filter component 121. The role of the AI-aided filter component 121 is similar to the filter component of FIG. 2, which is to provide a grouping of transmitters 103 as input for the load balancing scheme implemented in the packet processing circuit of device 107. The AI-based filter component 121 can be, for example, a deep Q-network optimizing the system according to a specific key performance indicator (KPI) (e.g., energy efficiency), but other AI algorithms can be used. In addition to the signal properties provided by digital twin 119, the AI-aided filter 121 gets an objective KPI value expressing the “goodness” of the system at the time of executing the component. The KPI calculation can incorporate different information sources, e.g.: (1) signal properties from digital twin 119, (2) load information for each transmitter 103, (3) and, optionally, any external information, e.g., real measurement data from the system or production level KPIs. An aim of the AI-aided filter component 121 is to provide a grouping of transmitters 103 that can maximize the KPI with the previously discussed load balancing scheme. Inclusion of the AI-aided filter 121 in the method may be referred to as a “blind setup” since the AI-aided filter 121 makes its decision solely based on the input data given by the digital twin 119 component.

Still referring to the example embodiment of FIG. 3, digital twin 119 simulates the environment and the signal properties in real-time/near real-time. The output of digital twin 119 includes the signal properties between receivers 111 and transmitters 103. The output of digital twin 119 is input to the AI-aided filter 121. Additional input to AI-aided filter 121 includes the objective KPI 301 value expressing the “goodness” of the system at the time of executing the AI-aided filter 121. The KPI calculation of the determined KPI 303 can incorporate different information sources, e.g.: (1) signal properties from digital twin 119, (2) load information 305 for each transmitter 103, (3) and, optionally, any external information 307, e.g., real measurement data from the system or production level KPIs.

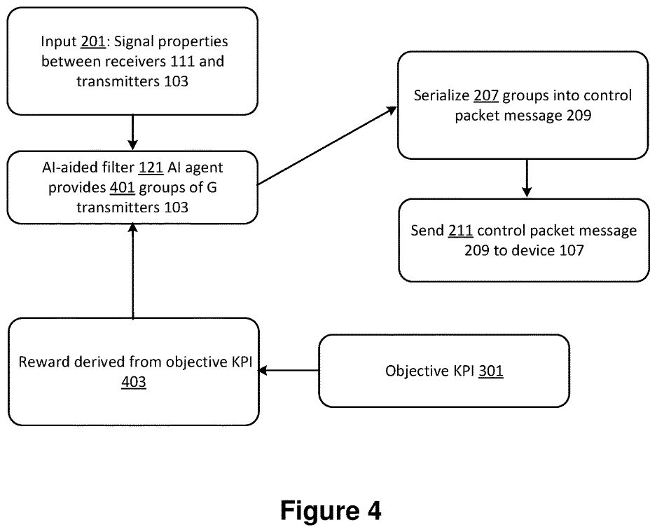

FIG. 4 is a flow chart of operations of an AI-aided filter in accordance with other embodiments of the present disclosure. The AI-aided filter (e.g., filter 121) receives input 201 including signal properties between a receiver 111 and all transmitters 103. The AI-aided filter 121 also receives input 403, which may be derived from the objective KPI 301 collected by an external system. The reward may be computed periodically from the objective KPI 301 provided by the system. In some embodiments, the inputs and the related decisions are also collected in a history, which may be used to update the model of the AI agent periodically. In operation 207, the AI-aided filter 121 serializes the groups G into a control packet message 209. For example, an identifier of each transmitter 103 may be listed sequentially in the control packet. The last group in the sequence may have fewer transmitters 103. In operation 211, the AI-aided filter 121 sends the control packet message 209 to device 107.

In a further example embodiment of an AI-aided system of components and operations, the system of the example embodiment of FIG. 4 includes an AI-aided system that can use more information (discussed further herein) for grouping the transmitters 103. Thus, in comparison with the AI-aided filter component using blind information from the above discussion of FIG. 4 is replaced with an AI-aided filter component 121 that can use more information. The AI-aided filter uses more because information because real-time/near real-time load information about the transmitters 103 is also used for grouping transmitters 103, in addition to the signal properties given by digital twin 119. Thus, this example embodiment merges simulation data with real-world monitoring information and uses both as input to optimize the KPI.

The programmable packet processing circuit (e.g., of device 107 in IRU 105) implements the load balancing operations in accordance with some embodiments of the present disclosure. In some embodiments, the load balancing operations of the method use accurate and real-time/near-real-time load information of the transmitters 103 and the transmitter 103 groups provided by the filter 121. The real-time/near real-time load information for each transmitter 103 is provided to the programmable packet processing circuit, and the programmable packet processing circuit selects the less loaded transmitters 103 from each group.

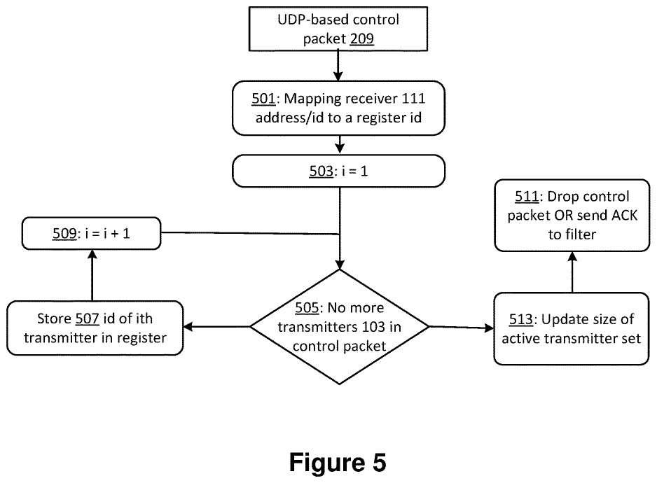

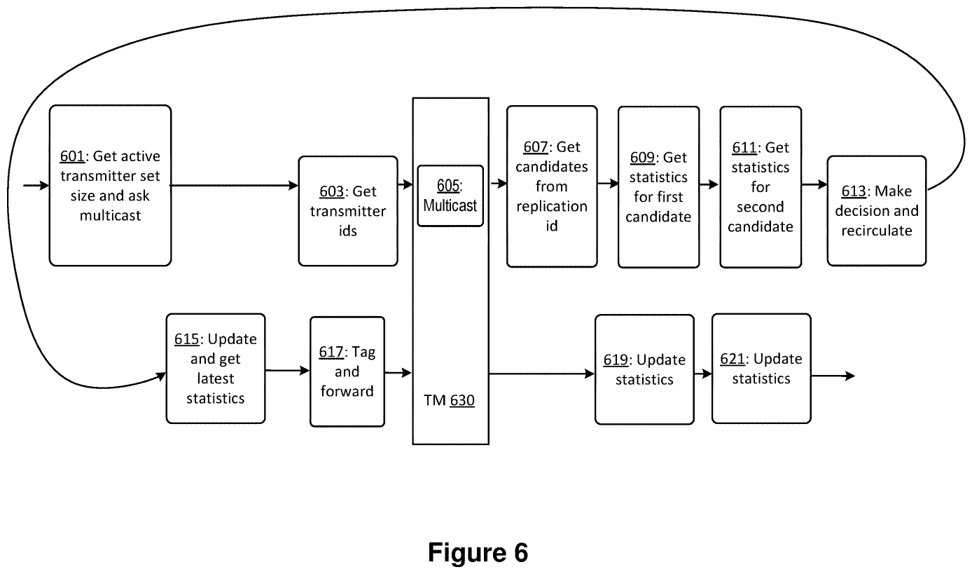

The operations of the programmable packet processing circuit (e.g., programmable switch/processing circuitry 902 of device 900 of FIG. 9) include, without limitation, three operations illustrated in the example embodiments depicted in FIGS. 5 and 6. FIG. 5 is a flowchart of operations for processing control packets in accordance with an example embodiment. FIG. 6 is a flowchart of operations, including some components, of an example embodiment of the data plane pipeline of group-wise load.

In a first operation, the programmable packet processing circuit handles control messages from the filter 121 in the data plane. In contrast to some existing approaches, the control packets provided by the filter 121 may be directly handled by the packet processing digital circuit (also known as handled in the data plane). Thus, communication overhead (e.g., 1-10 ms) may be eliminated between control and data planes of the packet processing circuit. For each receiver 111, the filter 121 (of any of the embodiments discussed herein) generates a status message/control packet whenever the grouping of transmitters 103 for a receiver 111 is changed. As illustrated in FIG. 5, in an example embodiment, each status message is encoded into a UDP-based control packet 209 and carries the new list of active transmitter 103 groups for a given receiver 111.

Inside the programmable packet processing circuit, the active set transmitters 103 are stored (e.g., in a register array). The identifier of the receiver 111 is mapped 501 to its register index, e.g., using a simple match-action table.

Still referring to FIG. 5, in this example embodiment, when the set of active transmitters 103 is limited to at most n elements, a data plane program may maintain n+1 register arrays: one register array (reg_{size}) is used for storing the number of active transmitters 103 (<=n) and each transmitter in the active set of transmitters 103 is stored in a separate register array instance (regᵢ) (e.g., n register arrays where the receiver's index position in the different instances stores the active elements) (e.g., because some programmable packet processing circuits have a limitation that the register can be touched only once during the pipeline).

Upon arrival of a new status message 209 for receiver R 111, the data plane program updates R 111's active set of transmitters 103 by filling the used register array instances at R 111's index position. That is, the receiver 111 is mapped 501 to its register index 503, e.g., using a simple match-action table. In operation 505, the data plane program determines whether there are more transmitters 103 in the control packet message 209. If yes, operation 507 stores an identifier of the ith transmitter 103 in the separate register array instance (regᵢ) in operation 509 where i=i+1. If no, in operation 513, the size of the active transmitter 103 set is updated; and in operation 511, the data plane pipeline can be finished by either dropping the status message or sending an acknowledgement message back to the filter 121.

It is noted that the active set values of the active set of transmitters 103 also may be stored in a match-action table, but in such an embodiment, the update includes control plane interaction, which may result in larger delays and central processing unit (CPU) load.

Referring to FIG. 6, in a second operation, the programmable packet processing circuit duplicates a transmission signal from the BBU (e.g., BBU 109). In some embodiments, downlink transmission signals encapsulated in Ethernet frames need to be forwarded (e.g., multicast) 605 to multiple transmitters 103 selected from the receiver 111's active set of transmitters from operation 601. When the transmission signal's destination is receiver R 111, R 111's index can be used to determine the current size of its active set of transmitters 103 and the number of copies to be created. The active transmitters 103 may be stored in a meta-header (operation 603 in FIG. 6, get transmitter ids) that is passed to an egress control (after traffic management ™ engine 630 in FIG. 6) where it is used for determining where the packet copies need to be forwarded.

The new copies are created by the multicast engine 605 of the programmable packet processing circuit that appear on the egress side of TM 630. In some embodiments, because rerouting is not possible on the egress pipeline of some circuits, e.g., Tofino ASIC, each copy may be recirculated in order to send them out on the correct port/towards the correct transmitter 103.

After recirculation, each copy can be distinguished in operation 615 and thus can be forwarded 617 to one of the transmitters listed in the active set of transmitters 111, including sending it out on the proper port, tagging it, or both. To this end, the ith replicated packet reads only the ith register instance and uses the read transmitter identifier to set routing (outgoing port, tagging, etc.).

In a third operation, the programmable packet processing circuit extends the first and second operations with load balancing. For each receiver, in operations 607-613, the method selects a fixed number (K) of transmitters from the active set of transmitters 111, where K is generally less than the number of active transmitters 111.

Because some programmable packet processing circuits (e.g., Tofino ASIC) have different constraints on the computational complexity and on the way registers and other external objects can be used, in some embodiments, the method includes the following operations. When the filter 121 sends the active-set of transmitters 103 in grouping order (e.g., active set=(1,2,3,4,5,6,7)), and when the group size is two, the grouping may be as follows: (1,2) (3,4), (5,6), (7) ).

It is noted that in this example embodiment, the last group is incomplete. Thus, in the method of this example embodiment, instead of forwarding transmission signal frames towards all the active transmitters 103, the method chooses only one transmitter 103 from each group according to various selection criteria. The selection criteria may include at least one of (1) random choice, and (2) load comparison-based selection. Random choice includes randomly selecting one of the transmitters 103 from each pair; which is stateless and may be easy to implement in the programmable packet processing circuits (e.g., a P4 programmable switch) with a small overhead. Load comparison-based selection includes using available external components (e.g., registers, low pass filters, etc.), monitoring the transmitters' 103 load, and choosing the less stressed transmitter from each pair of transmitters 103.

Referring again to FIG. 6, an implementation of this example embodiment includes hardware targets that may pose particular constraints when stateful objects like registers or low pass filters are used. For example, such external objects may only be touched once during the packet processing pipeline. Thus, this example embodiment computes an exponentially weighted moving average of packet rates to keep track of the usage statistics of each transmitter 103. The load statistics may be needed at two different points of the pipeline: (1) in operation 613, to read the load values for the comparison of load values in each group, and (2) in operations 619 and 621, after the decision is made, to update their value since the outgoing packets needs to be taken into account in the load statistics. In the example embodiment, this is addressed by introducing two additional register arrays (e.g., as cache registers) at operations 619 and 621, respectively, that contain the last load statistics calculated for the transmitters 103 of each pair of transmitters. For example, the cache register for operation 619 may be an even cache register that caches the last load statistics (e.g., rate values) for transmitters 103 having an even numbered identifier, and the cache register for operation 621 may be an odd cache register that caches the last load statistics (e.g., rate values) for transmitters 103 having an odd numbered identifier. These stored values are used in the group-wise load comparison. After one recirculation of operations 601-621, the statistics can be updated 615 and the new values can be stored in the appropriate cache registers in operations 619 and 621. It is noted that if a transmitter 103 is not selected after a certain point of time, the cache will not be updated for this transmitter 103, which may cause potentially sub-optimal decisions. Thus, in some embodiments, the method includes keeping the cache up to date with negligible overhead (e.g., periodically generating extra packets to force the update then drop these packets, or the control plane can reset the unused cache registers after a predefined timeout, etc.).

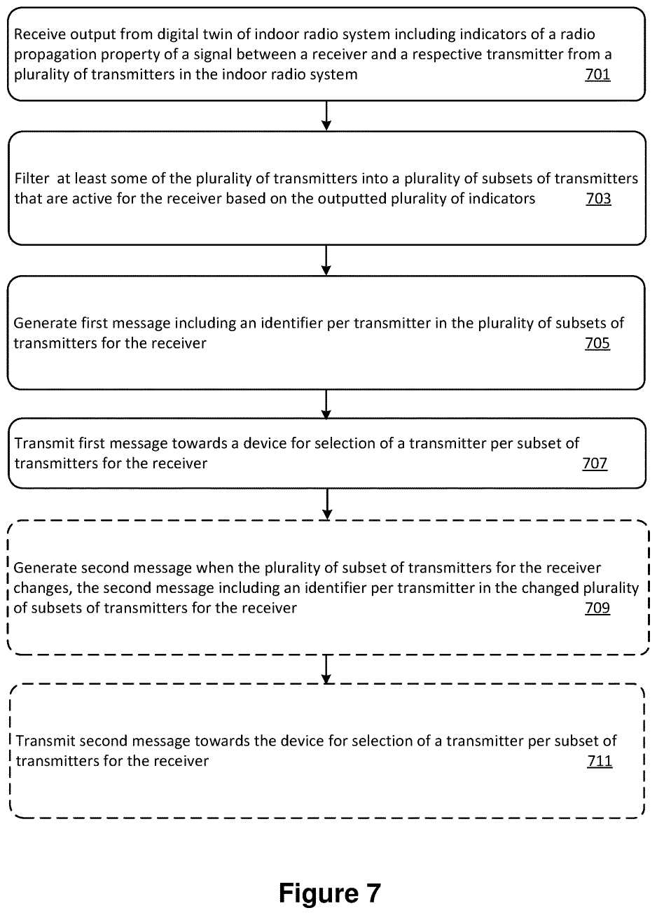

Operations of a network node (e.g., 117, 1000) (implemented using the structure of FIG. 10) will now be discussed with reference to the flow chart of FIG. 7 according to some embodiments of the present disclosure. For example, modules may be stored in memory 1004 of FIG. 10, and these modules may provide instructions so that when the instructions of a module are executed by respective network node processing circuitry 1002, network node 1000 performs respective operations of the flow chart,

Referring to FIG. 7, a method performed by a network node (e.g., 117, 1000) for selection of transmitters in an indoor radio system is provided. The method includes receiving (701) an output from a DT of the indoor radio system. The output includes a plurality of indicators of a radio propagation property of a signal between a receiver and a respective transmitter from a plurality of transmitters in the indoor radio system. The method further includes filtering (703) at least some of the plurality of transmitters into a plurality of subsets of transmitters that are active for the receiver based on the outputted plurality of indicators; and generating (705) a first message including an identifier per transmitter in the plurality of subsets of transmitters for the receiver. The method further includes transmitting (707) the first message towards a device for selection of a transmitter per subset of transmitters for the receiver.

The plurality of indicators of the radio propagation property of the signal may include a plurality of values representing a quality of the signal between the receiver and the respective transmitter from the plurality of transmitters.

The filtering (703) may include sorting the plurality of at least some of the plurality of transmitters into an ordered list of transmitters according to the plurality of indicators; and grouping the transmitters from the ordered list into the plurality of subsets of transmitters according to a ranked order of the transmitters from the ordered list.

The plurality of subsets of transmitters may include pairs of transmitters formed into the pairs according to the ranked order of the transmitters from the ordered list.

Respective transmitters in a subset of transmitters may include transmitters having a value of respective indicators that is about the same and/or transmitters having a value of a respective indicator that meets a specified value of a threshold.

The filtering (703) may include an AI aided filtering process. The AI aided filtering process may include grouping the plurality of subsets of transmitters based on respective groups of the transmitters that maximize a reward derived from a KPI of the indoor radio system given by one or more of (i) the plurality of indicators of the radio propagation property of the signal, (ii) a value of a load of respective transmitters selected by the device, and (iii) other information from or related to the indoor radio system. The grouping the plurality of subsets of transmitters may be further based on receiving respective load values of the transmitters from the indoor radio system that is included in maximizing the reward derived from the KPI.

The first message may include a control packet that carries the identity of each transmitter in the plurality of subsets of transmitters.

The device may handle the first message in a data plane.

In some embodiments, the method further includes generating (709) a second message when the plurality of subset of transmitters for the receiver changes. The second message includes an identifier per transmitter in the changed plurality of subsets of transmitters for the receiver. The method may further include transmitting (711) the second message towards the device for selection of a transmitter per subset of transmitters for the receiver.

Various operations from the flow chart of FIG. 7 may be optional with respect to some embodiments of network nodes and related methods. For example, operations of blocks 709 and 711 of FIG. 7 may be optional.

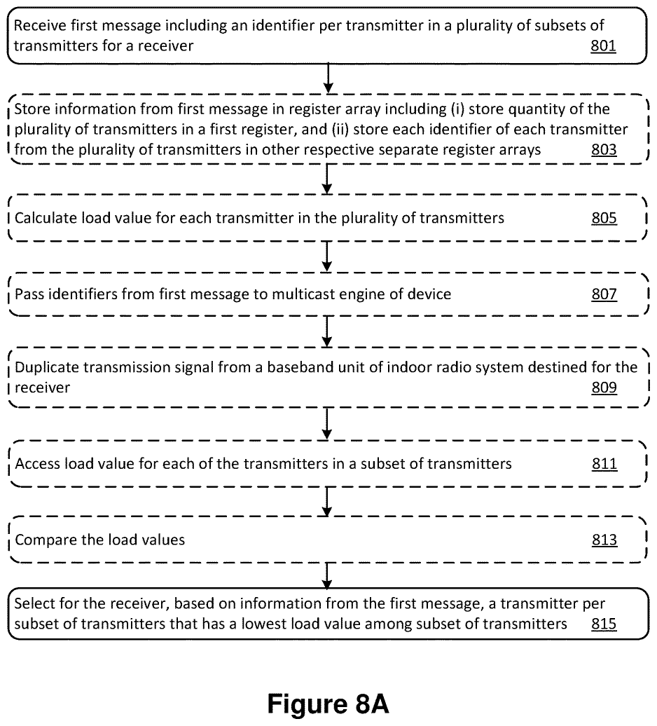

Operations of a device (e.g., 107, 900) (implemented using the structure of FIG. 9) will now be discussed with reference to the flow charts of FIGS. 8A and 8B according to some embodiments of the present disclosure. For example, modules may be stored in memory 904, including one or more of register arrays 906, of FIG. 9, and these modules may provide instructions so that when the instructions of a module are executed by respective device processing circuitry 902, device 900 performs respective operations of the flow chart.

Referring to FIG. 8A, a method performed by a device (e.g., 107, 900) for selection of transmitters in an indoor radio system is provided. The method includes receiving (801) a first message including an identifier per transmitter in a plurality of subsets of transmitters for a receiver; and selecting (815) for the receiver, based on information from the first message, a transmitter per subset of transmitters that has a lowest load value among the subset of transmitters.

Respective transmitters in the subset of transmitters may include transmitters having a value of a respective indicator of a radio propagation property of a signal between a respective transmitter in the subset and the receiver that meets a threshold value.

The plurality of subsets of transmitters may include pairs of transmitters formed into the pairs. The pairs may have a value that is about the same of respective indicators of the radio propagation property of a signal between a respective transmitter in the pair and the receiver.

The method may further include storing (803) information from the first message in a register array including (i) storing a quantity of the plurality of transmitters in a first register of the register array, and (ii) storing each identifier of each transmitter from the plurality of transmitters in other respective separate register arrays.

In some embodiments, the method further includes calculating (805) a load value for each transmitter in the plurality of transmitters.

In some embodiments, the method further includes passing (807) the identifiers from the first message to a multicast engine of the device; duplicating (809) a transmission signal from a baseband unit of the indoor radio system destined for the receiver; accessing (811) a load value for each of the transmitters in a subset of transmitters; and comparing (813) the load values.

The accessing (811) may include accessing the load value for each of the transmitters from a separate register in a register array.

Referring to FIG. 8B, in some embodiments, the method further includes recirculating (817) the duplicated transmission signal for transmission of the duplicated transmission signal towards the selected transmitters.

In some embodiments, the method further includes transmitting (819) the supplicated transmission signal towards the selected transmitters.

In some embodiments, the method further includes receiving (821) a second message comprising an identifier per transmitter in a changed plurality of subsets of transmitters for a receiver; and updating (823) the register array with the information from the second message. The updating may include (i) storing a quantity of the changed plurality of transmitters in the first register of the register array, and (ii) storing each identifier of each transmitter from the changed plurality of transmitters in the corresponding other respective separate register array.

In some embodiments, the method further includes selecting (825) for the receiver, based on information from the second message, a transmitter per subset of transmitters that has a lowest load value among the subset of transmitters.

In some embodiments, the device is located in an indoor radio unit. The device may operate to switch on and off the transmitters (e.g., transmitters 103).

Various operations from the flow charts of FIGS. 8A and 8B may be optional with respect to some embodiments of a method performed by a device. For example, operations of blocks 803-813 of FIG. 8A may be optional and operations of blocks 817-825 of FIG. 8B may be optional.

For an example embodiment of the method of the present disclosure, measurements were performed in an integrated emulated environment. The method included a filter of the present disclosure that was not an AI-aided filter. The method resulted in 60% energy saving compared to a default CoMP transmission and reception case.

For this example embodiment, comparison of the maximum load experienced in the system with CoMP (that is, no load balancing (“noLB”), with random selection (that is, random load balancing (“LB)), and group-wised load balancing of the present disclosure (“compared LB”) showed that the compared LB had the lowest maximum load in the simulated scenario with one second aggregation; and that compared LB in the simulated scenario had the lowest distribution of observed load values on the transmitters.

In another example embodiment, the same scenario was evaluated on an actual Tofino ASIC programmable switch. While the example embodiment included a Tofino ASIC programmable switch, the present disclosure is not so limited, and includes other programmable switches or in-network computation devices (e.g., Edgecore, Stordis, Asterfusion® CX-T P4, etc. programmable switches, and/or Pensando distributed services card (DSC), Netronome Agilio, Xilinx Alveo, etc. in-network computation devices). The results were similar, but the difference between the random selection LB and the compared LB was less, which illustrated that in this example embodiments, the grouping given by the filtering of the method may be more important in the overall performance in some embodiments.

As discussed herein network node 1000 of FIG. 10 may be implemented as computing device. The computing device may be in the cloud and/or a virtual machine, which may include DT 119 and filter 121 or communicative coupling to DT 119 and filter 121, all of which should be considered interchangeable in the examples and embodiments described herein and be within the intended scope of this disclosure, unless otherwise noted. As shown in FIG. 10, the network node may include communication interface 1006 including a transmitter and a receiver configured to provide uplink and downlink radio communications with the indoor radio system. The network node may also include processing circuitry 1002 (also referred to as a processor) coupled to the communication interface 1006, DT 119, filter 121, power source 1008, and memory circuitry 1004 (also referred to as memory). The memory circuitry 1004 may include computer readable program code that when executed by the processing circuitry 1002 causes the processing circuitry to perform operations according to embodiments disclosed herein. According to other embodiments, processing circuitry 1002 may be defined to include memory so that a separate memory circuitry is not required. According to some embodiments, network node 1000 and/or an element(s)/function(s) thereof may be embodied as a virtual node/nodes and/or a virtual machine/machines.

As discussed herein device 900 of FIG. 9 may be implemented in an IRU and/or communicatively coupled with an IRU (or an equipment performing the functions of an IRU for the indoor radio system), all of which should be considered interchangeable in the examples and embodiments described herein and be within the intended scope of this disclosure, unless otherwise noted. As shown in FIG. 9, the device may include a programmable switch/processing circuitry 902 (also referred to as a processor) and memory circuitry 904 (also referred to as memory). The memory circuit 904 may include register arrays 906. The memory circuitry 904 may further include computer readable program code that when executed by the processing circuitry 902 causes the processing circuitry to perform operations according to embodiments disclosed herein. According to other embodiments, processing circuitry 902 may be defined to include at least some of memory 904. The device may include ports 906, including transmit ports 908 and receive ports 910, configured to provide uplink and downlink radio communications with the indoor radio system.

Although device 900 and network node 1000 are illustrated in the example block diagrams of FIGS. 9 and 10 each may represent a device that includes the illustrated combination of hardware components, other embodiments may comprise devices and network nodes with different combinations of components. It is to be understood that each of a device and a network node comprise any suitable combination of hardware and/or software needed to perform the tasks, features, functions, and methods disclosed herein. Moreover, while the components of each of a device and a network node are depicted as single boxes located within a larger box, or nested within multiple boxes, in practice, each device may comprise multiple different physical or virtual components that make up a single illustrated component (e.g., a memory may comprise multiple separate hard drives as well as multiple RAM modules).

In the above description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

### LISTING OF EMBODIMENTS

1. A method of selection of transmitters in an indoor radio system, the method comprising:
receiving (701) an output from a digital twin of the indoor radio system, the output comprising a plurality of indicators of a radio propagation property of a signal between a receiver and a respective transmitter from a plurality of transmitters in the indoor radio system;
filtering (703) at least some of the plurality of transmitters into a plurality of subsets of transmitters that are active for the receiver based on the outputted plurality of indicators;
generating (705) a first message comprising an identifier per transmitter in the plurality of subsets of transmitters for the receiver; and
transmitting (707) the first message towards a device for selection of a transmitter per subset of transmitters for the receiver.

2. The method according to Embodiment 2, wherein the plurality of indicators of the radio propagation property of the signal comprises a plurality of values representing a quality of the signal between the receiver and the respective transmitter from the plurality of transmitters.

3. The method according to any one of Embodiments 1 to 2, wherein the filtering (703) comprises:
sorting the plurality of at least some of the plurality of transmitters into an ordered list of transmitters according to the plurality of indicators; and
grouping the transmitters from the ordered list into the plurality of subsets of transmitters according to a ranked order of the transmitters from the ordered list.

4. The method of Embodiment 3, wherein the plurality of subsets of transmitters comprise pairs of transmitters formed into the pairs according to the ranked order of the transmitters from the ordered list.

5. The method according to any one of Embodiments 3 to 4, wherein respective transmitters in a subset of transmitters comprise transmitters having a value of respective indicators that is about the same.

6. The method of any one of Embodiments 3 to 5, wherein respective transmitters in a subset of transmitters comprise transmitters having a value of a respective indicator that meets a specified value of a threshold.

7. The method according to any one of Embodiments 1 to 6, wherein the filtering (703) comprises an artificial intelligence, AI, aided filtering process.

8. The method of embodiment 7, wherein the AI aided filtering process comprises:
grouping the plurality of subsets of transmitters based on respective groups of the transmitters that maximize a reward derived from a key performance indicator, KPI, of the indoor radio system given by one or more of (i) the plurality of indicators of the radio propagation property of the signal, (ii) a value of a load of respective transmitters selected by the device, and (iii) other information from or related to the indoor radio system.

9. The method of Embodiment 8, wherein the grouping the plurality of subsets of transmitters is further based on receiving respective load values of the transmitters from the indoor radio system that is included in maximizing the reward derived from the KPI.

10. The method according to any one of Embodiments 1 to 9, wherein the first message comprises a control packet that carries the identity of each transmitter in the plurality of subsets of transmitters.

11. The method according to any one of Embodiments 1 to 10, wherein the device handles the first message in a data plane.

12. The method according to any one of Embodiments 1 to 11, further comprising:
generating (709) a second message when the plurality of subset of transmitters for the receiver changes, the second message comprising an identifier per transmitter in the changed plurality of subsets of transmitters for the receiver; and
transmitting (711) the second message towards the device for selection of a transmitter per subset of transmitters for the receiver.

13. A method performed by a device for selection of transmitters in an indoor radio system, the method comprising:
receiving (801) a first message comprising an identifier per transmitter in a plurality of subsets of transmitters for a receiver; and
selecting (815) for the receiver, based on information from the first message, a transmitter per subset of transmitters that has a lowest load value among the subset of transmitters.

14. The method of Embodiment 13, wherein respective transmitters in the subset of transmitters comprise transmitters having a value of a respective indicator of a radio propagation property of a signal between a respective transmitter in the subset and the receiver that meets a threshold value.

15. The method according to any one of Embodiments 13 to 14, wherein the plurality of subsets of transmitters comprise pairs of transmitters formed into the pairs, the pairs having a value that is about the same of respective indicators of the radio propagation property of a signal between a respective transmitter in the pair and the receiver.

16. The method according to any one of Embodiments 13 to 15, further comprising:
storing (803) information from the first message in a register array comprising (i) storing a quantity of the plurality of transmitters in a first register of the register array, and (ii) storing each identifier of each transmitter from the plurality of transmitters in other respective separate register arrays.

17. The method according to any one of Embodiments 13 to 16, further comprising:
calculating (805) a load value for each transmitter in the plurality of transmitters.

18. The method according to any one of Embodiments 13 to 17, further comprising:
passing (807) the identifiers from the first message to a multicast engine of the device; and
duplicating (809) a transmission signal from a baseband unit of the indoor radio system destined for the receiver;
accessing (811) a load value for each of the transmitters in a subset of transmitters; and
comparing (813) the load values.

19. The method according to Embodiment 18, wherein the accessing (811) comprises accessing the load value for each of the transmitters from a separate register in a register array.

20. The method according to any one of Embodiments 18 to 19, further comprising:
recirculating (817) the duplicated transmission signal for transmission of the duplicated transmission signal towards the selected transmitters.

21. The method of Embodiment 20, further comprising: transmitting (819) the supplicated transmission signal towards the selected transmitters.

22. The method according to Embodiment 21, further comprising:
receiving (821) a second message comprising an identifier per transmitter in a changed plurality of subsets of transmitters for a receiver; and
updating (823) the register array with the information from the second message, wherein the updating comprises (i) storing a quantity of the changed plurality of transmitters in the first register of the register array, and (ii) storing each identifier of each transmitter from the changed plurality of transmitters in the corresponding other respective separate register array.

23. The method of Embodiment 22, further comprising:
selecting (825) for the receiver, based on information from the second message, a transmitter per subset of transmitters that a lowest load value among the subset of transmitters.

24. The method according to any one of Embodiments 13 to 23, wherein the device is located in an indoor radio unit.

25. A network node (117, 1000), the network node comprising:
processing circuitry (1002);
memory (1004) coupled with the processing circuitry, wherein the memory includes instructions that when executed by the processing circuitry causes the network node to perform operations comprising:
receive an output from a digital twin of the indoor radio system, the output comprising a plurality of indicators of a radio propagation property of a signal between a receiver and a respective transmitter from a plurality of transmitters in the indoor radio system;
filter at least some of the plurality of transmitters into a plurality of subsets of transmitters that are active for the receiver based on the outputted plurality of indicators;
generate a first message comprising an identifier per transmitter in the plurality of subsets of transmitters for the receiver; and
transmit the first message towards a device for selection of a transmitter per subset of transmitters for the receiver.

26. The network node of Embodiment 25, wherein the memory includes instructions that when executed by the processing circuitry causes the network node to perform further operations comprising any of the operations of any one of Embodiments 2 to 12.

27. A network node (117, 1000), the network node adapted to perform operations comprising:
receive an output from a digital twin of the indoor radio system, the output comprising a plurality of indicators of a radio propagation property of a signal between a receiver and a respective transmitter from a plurality of transmitters in the indoor radio system;
filter at least some of the plurality of transmitters into a plurality of subsets of transmitters that are active for the receiver based on the outputted plurality of indicators;
generate a first message comprising an identifier per transmitter in the plurality of subsets of transmitters for the receiver; and
transmit the first message towards a device for selection of a transmitter per subset of transmitters for the receiver.

28. The network node of Embodiment 27 adapted to perform further operations according to any one of Embodiments 2 to 12.

29. A computer program comprising program code to be executed by processing circuitry (1002) of a network node (117, 1000), whereby execution of the program code causes the network node to perform operations comprising:
receive an output from a digital twin of the indoor radio system, the output comprising a plurality of indicators of a radio propagation property of a signal between a receiver and a respective transmitter from a plurality of transmitters in the indoor radio system;
filter at least some of the plurality of transmitters into a plurality of subsets of transmitters that are active for the receiver based on the outputted plurality of indicators;
generate a first message comprising an identifier per transmitter in the plurality of subsets of transmitters for the receiver; and
transmit the first message towards a device for selection of a transmitter per subset of transmitters for the receiver.

30. The computer program of Embodiment 29, whereby execution of the program code causes the network node to perform operations according to any one of Embodiments 2 to 12.

31. A computer program product comprising a non-transitory storage medium (1004) including program code to be executed by processing circuitry (1002) of a network node (117, 1000), whereby execution of the program code causes the network node to perform operations comprising:
receive an output from a digital twin of the indoor radio system, the output comprising a plurality of indicators of a radio propagation property of a signal between a receiver and a respective transmitter from a plurality of transmitters in the indoor radio system;
filter at least some of the plurality of transmitters into a plurality of subsets of transmitters that are active for the receiver based on the outputted plurality of indicators;
generate a first message comprising an identifier per transmitter in the plurality of subsets of transmitters for the receiver; and
transmit the first message towards a device for selection of a transmitter per subset of transmitters for the receiver.

32. The computer program product of Embodiment 31, whereby execution of the program code causes the network node to perform operations according to any one of Embodiments 2 to 12.

33. A device (107, 900), the device comprising:
processing circuitry (902);
memory (904) coupled with the processing circuitry, wherein the memory includes instructions that when executed by the processing circuitry causes the device to perform operations comprising:
receive a first message comprising an identifier per transmitter in a plurality of subsets of transmitters for a receiver; and
select for the receiver, based on information from the first message, a transmitter per subset of transmitters that has a lowest load value among the subset of transmitters.

34. The network node of Embodiment 33, wherein the memory includes instructions that when executed by the processing circuitry causes the device to perform further operations comprising any of the operations of any one of Embodiments 14 to 24.

35. A device (107, 900), the device adapted to perform operations comprising:
receive a first message comprising an identifier per transmitter in a plurality of subsets of transmitters for a receiver; and
select for the receiver, based on information from the first message, a transmitter per subset of transmitters that has a lowest load value among the subset of transmitters.

36. The device of Embodiment 35 adapted to perform further operations according to any one of Embodiments 14 to 24.

37. A computer program comprising program code to be executed by processing circuitry (902) of a device (107, 900), whereby execution of the program code causes the device to perform operations comprising:
receive a first message comprising an identifier per transmitter in a plurality of subsets of transmitters for a receiver; and
select for the receiver, based on information from the first message, a transmitter per subset of transmitters that has a lowest load value among the subset of transmitters.

38. The computer program of Embodiment 37, whereby execution of the program code causes the device to perform operations according to any one of Embodiments 14 to 24.

39. A computer program product comprising a non-transitory storage medium (904) including program code to be executed by processing circuitry (902) of a device (107, 900), whereby execution of the program code causes the device to perform operations comprising:
receive a first message comprising an identifier per transmitter in a plurality of subsets of transmitters for a receiver; and
select for the receiver, based on information from the first message, a transmitter per subset of transmitters that has a lowest load value among the subset of transmitters.

40. The computer program product of Embodiment 39, whereby execution of the program code causes the device to perform operations according to any one of Embodiments 14 to 24.

1. A method of selection of transmitters in an indoor radio system, the method comprising:
receiving an output from a digital twin of the indoor radio system, the output comprising a plurality of indicators of a radio propagation property of a signal between a receiver and a respective transmitter from a plurality of transmitters in the indoor radio system;
filtering at least some of the plurality of transmitters into a plurality of subsets of transmitters that are active for the receiver based on the outputted plurality of indicators;
generating a first message comprising an identifier per transmitter in the plurality of subsets of transmitters for the receiver; and
transmitting the first message towards a device for selection of a transmitter per subset of transmitters for the receiver.

2. The method according to claim 2, wherein the plurality of indicators of the radio propagation property of the signal comprises a plurality of values representing a quality of the signal between the receiver and the respective transmitter from the plurality of transmitters.

3. The method according to claim 1, wherein the filtering comprises:
sorting the plurality of at least some of the plurality of transmitters into an ordered list of transmitters according to the plurality of indicators; and
grouping the transmitters from the ordered list into the plurality of subsets of transmitters according to a ranked order of the transmitters from the ordered list.

4. The method of claim 3, wherein the plurality of subsets of transmitters comprise pairs of transmitters formed into the pairs according to the ranked order of the transmitters from the ordered list.

5. The method according to claim 3, wherein respective transmitters in a subset of transmitters comprise transmitters having a value of respective indicators that is about the same.

6. The method of claim 3, wherein respective transmitters in a subset of transmitters comprise transmitters having a value of a respective indicator that meets a specified value of a threshold.

7. The method according to claim 1, wherein the filtering comprises an artificial intelligence, AI, aided filtering process.

8. The method of claim 7, wherein the AI aided filtering process comprises:
grouping the plurality of subsets of transmitters based on respective groups of the transmitters that maximize a reward derived from a key performance indicator, KPI, of the indoor radio system given by one or more of (i) the plurality of indicators of the radio propagation property of the signal, (ii) a value of a load of respective transmitters selected by the device, and (iii) other information from or related to the indoor radio system.

9. The method of claim 8, wherein the grouping the plurality of subsets of transmitters is further based on receiving respective load values of the transmitters from the indoor radio system that is included in maximizing the reward derived from the KPI.

10. The method according to claim 1, wherein the first message comprises a control packet that carries the identity of each transmitter in the plurality of subsets of transmitters.

11. The method according to claim 1, wherein the device handles the first message in a data plane.

12. The method according to claim 1, further comprising:
generating a second message when the plurality of subset of transmitters for the receiver changes, the second message comprising an identifier per transmitter in the changed plurality of subsets of transmitters for the receiver; and
transmitting the second message towards the device for selection of a transmitter per subset of transmitters for the receiver.

13. A method performed by a device for selection of transmitters in an indoor radio system, the method comprising:
receiving a first message comprising an identifier per transmitter in a plurality of subsets of transmitters for a receiver; and
selecting for the receiver, based on information from the first message, a transmitter per subset of transmitters that has a lowest load value among the subset of transmitters.

14. The method of claim 13, wherein respective transmitters in the subset of transmitters comprise transmitters having a value of a respective indicator of a radio propagation property of a signal between a respective transmitter in the subset and the receiver that meets a threshold value.

15. The method according to claim 13, wherein the plurality of subsets of transmitters comprise pairs of transmitters formed into the pairs, the pairs having a value that is about the same of respective indicators of the radio propagation property of a signal between a respective transmitter in the pair and the receiver.

16. The method according to claim 13, further comprising:
storing information from the first message in a register array comprising (i) storing a quantity of the plurality of transmitters in a first register of the register array, and (ii) storing each identifier of each transmitter from the plurality of transmitters in other respective separate register arrays.

17. The method according to claim 13, further comprising:
calculating a load value for each transmitter in the plurality of transmitters.

18. The method according to claim 13, further comprising:
passing the identifiers from the first message to a multicast engine of the device; and
duplicating a transmission signal from a baseband unit of the indoor radio system destined for the receiver;
accessing a load value for each of the transmitters in a subset of transmitters; and
comparing the load values.

19-24. (canceled)

25. A network node the network node comprising:
processing circuitry
memory coupled with the processing circuitry, wherein the memory includes instructions that when executed by the processing circuitry causes the network node to perform operations comprising:
receive an output from a digital twin of the indoor radio system, the output comprising a plurality of indicators of a radio propagation property of a signal between a receiver and a respective transmitter from a plurality of transmitters in the indoor radio system;
filter at least some of the plurality of transmitters into a plurality of subsets of transmitters that are active for the receiver based on the outputted plurality of indicators;
generate a first message comprising an identifier per transmitter in the plurality of subsets of transmitters for the receiver; and
transmit the first message towards a device for selection of a transmitter per subset of transmitters for the receiver.

26. (canceled)

27. A network node the network node adapted to perform operations comprising:
receive an output from a digital twin of the indoor radio system, the output comprising a plurality of indicators of a radio propagation property of a signal between a receiver and a respective transmitter from a plurality of transmitters in the indoor radio system;
filter at least some of the plurality of transmitters into a plurality of subsets of transmitters that are active for the receiver based on the outputted plurality of indicators;
generate a first message comprising an identifier per transmitter in the plurality of subsets of transmitters for the receiver; and
transmit the first message towards a device for selection of a transmitter per subset of transmitters for the receiver.

28-40. (canceled)
